(19) United States
(12) Patent Application Publication
(10) Pub. No.: US 2022/0212578 A1
(43) Pub. Date: Jul. 7, 2022

(54) ERGONOMIC SEATING SYSTEM AND METHOD OF USE

(71) Applicant: Lars Roulund, Laguna Beach, CA (US)

(72) Inventor: Lars Roulund, Laguna Beach, CA (US)

(21) Appl. No.: 17/557,674

(22) Filed: Dec. 21, 2021

Related U.S. Application Data
(60) Provisional application No. 63/133,565, filed on Jan. 4, 2021.

(51) Int. Cl. B60N 2/66; B60N 2/90

(52) U.S. Cl. CPC B60N 2/665; B60N 2/5816; B60N 2/919; B60N 2/914

(57) ABSTRACT

A seat cover is configured to be disposable on a seat to provide selectively adjustable support to a user seated on the seat. The seat cover comprises a cover layer configured to be extendable over at least a portion of the seat. A pump is connected to the cover layer and is configured to supply fluid under pressure. A first bladder compartment is connected to the pump to receive fluid under pressure therefrom. A second bladder compartment is also connected to the pump to receive fluid under pressure therefrom. A manifold is fluidly connected to the pump, the first bladder compartment, and the second bladder compartment. The manifold is configured to selectively direct fluid from the pump to the first and second bladder compartments to achieve a first prescribed pressure in the first bladder compartment and a second prescribed pressure in the second bladder compartment.

### CROSS-REFERENCE TO RELATED APPLICATIONS

The present application claims the benefit of U.S. Provisional Application Ser. No. 63/133,565, filed Jan. 4, 2021, the contents of which are expressly incorporated herein by reference.

### STATEMENT RE: FEDERALLY SPONSORED RESEARCH/DEVELOPMENT

Not Applicable

### BACKGROUND

### 1. Technical Field

The present disclosure relates generally to a seat cushion and more specifically to a seat cushion configured to allow for selective adjustment to a degree of support provided by the seat cushion.

### 2. Description of the Related Art

Seating, in general, has not undergone significant changes in hundreds of years. Most seating surfaces are given little thought when designed, and are constituted of generally the same minimal components, i.e., a lower support that can be as simple as a hard base plate or spring configurations and topped with foam and covered with a material covering. Medical research and clinical studies have shown that the human body may attempt to compensate for differences in seating surfaces, which can be unhealthy and lead to skin damage, muscular damage, and skeletal damage that may result in reduced mobility and pain. When sitting for extended periods of time, the pain that one may experience may be referred to as “ischemic pain.” Unfortunately, many individuals sit on a seating surface that is unhealthy, causing slow, progressive, and sometimes irreversible damage to the buttock, skin and internal tissue between the skin surface and the skeletal structure.

Recent advancements have been made to improve user ergonomics or comfort in seating surfaces. However, such advancements are typically limited due to every body having unique contours and characteristics. Science has shown that the skeletal structure throughout all humans is generally similar. In particular, the pelvic bone and, more importantly, the Ischial Tuberosities (sit bones or IT's), which are the two boney points that protrude downward from the pelvic bone are common. In nearly all adult skeletal structures these two prominent boney points, IT's, are within ⅝″ distance from one IT to the other IT for the entire adult population. Through medical research specifically related to wheelchair recipients, it has been shown that pain and tissue damage typically starts at the IT's through downward sitting pressure on muscle, fatty tissue and skin ultimately cutting off blood flow between the skin surface and the IT's ending with tissue damage through shearing and ultimately forming pressure ulcers. Over 2.5 million wheelchair and bed ridden patients are diagnosed with pressure ulcers annually, with 60,000 patents dying from their ulcer wounds. An average of cost of $43,000.00 is estimated to medically treat and heal a patient having a pressure ulcer.

Roho, Inc. of Belleville, Ill. is the leader in air cell technology that dissipates weight load on bed ridden and wheelchair recipients. The ROHO product has been shown to prevent pressure ulcers and, in many cases, may heal them. ROHO refers to its technology as dry floatation® technology. Currently, the air bladders used in the ROHO dry floatation® products are filled by use of a small hand pump and either adjusted manually by a skilled medical technician using their hand as a judgement point or by using a medical pressure mapping system. However, such manual adjustment requirement is inaccurate and such dry flotation technology has not been developed for general residential and/or commercial seating applications.

Accordingly, there is a need in the art for a seating device that is adaptable to provide customizable support to a user to suit the unique needs of the user. Various aspects of the present disclosure address this particular need, as will be discussed in more detail below.

### BRIEF SUMMARY

In accordance with one embodiment of the present disclosure, a seat cover is configured to be disposable on a seat to provide selectively adjustable support to a user seated on the seat. The seat cover comprises a cover layer configured to be extendable over at least a portion of the seat. A pump is connected to the cover layer and is configured to supply fluid under pressure. A first bladder compartment is connected to the pump to receive fluid under pressure therefrom. A second bladder compartment is also connected to the pump to receive fluid under pressure therefrom. A manifold is fluidly connected to the pump, the first bladder compartment, and the second bladder compartment. The manifold is configured to selectively direct fluid from the pump to the first and second bladder compartments to achieve a first prescribed pressure in the first bladder compartment and a second prescribed pressure in the second bladder compartment.

The seat cover may additionally include a controller in communication with the pump and the manifold. The controller is configured to generate operational commands for both the pump and the manifold to achieve the first prescribed pressure and the second prescribed pressure. The seat cover may further include a first pressure sensor in fluid communication with the first bladder compartment to sense pressure within the first bladder compartment and a second pressure sensor in fluid communication with the second pressure to sense pressure within the second bladder compartment. The first and second pressure sensors may be in operative communication with the controller. The controller may be configured to generate the operational commands for both the pump and the manifold based, at least in part, on the sensed pressures from the first pressure sensor and the second pressure sensor.

The seat cover may additionally include a user interface configured to receive a first user input signal associated with the first prescribed pressure and a second user input signal associated with the second prescribed pressure.

The seat cover may further comprise a communications circuit in operative communication with the controller, with the communications circuit being configured to facilitate communication with an external computer.

The seat cover may include a first set of bladder compartments, with the first bladder compartment being one of the first set of bladder compartments, and a second set of bladder compartments, with the second bladder compartment being one of the second set of bladder compartments.

The manifold may include a plurality of outlets, with each outlet being fluidly connected to a respective one of the first bladder compartment and the second bladder compartment. At least one valve body may be in operative communication plurality of outlets. The at least one valve body may be transitional between a first position, wherein each outlet fluidly connected to the first bladder compartment is open and each outlet fluid connected to the second bladder compartment is closed, and a second position, wherein each outlet fluid connected to the second bladder compartment is open and each outlet fluidly connected to the first bladder compartment is closed.

The manifold may include an exhaust outlet configured to facilitate exhausting of fluid from both the first bladder compartment and the second bladder compartment.

According to another embodiment, a seat is configured to provide selectively adjustable support to a user seated thereon. The seat includes a seat body and a pump connected to the seat body and configured to supply fluid under pressure. A first bladder compartment is connected to the pump to receive fluid under pressure therefrom. A second bladder compartment is connected to the pump to receive fluid under pressure therefrom. A manifold is fluidly connected to the pump, the first bladder compartment, and the second bladder compartment. The manifold is configured to selectively direct fluid from the pump to the first and second bladder compartments to achieve a first prescribed pressure in the first bladder compartment and a second prescribed pressure in the second bladder compartment.

According to yet another embodiment, a method of adjusting support provided by a seat cover includes receiving a first input signal associated with a first support level in a first support zone, and a second input signal associated with a second support level in a second support zone. The first support zone includes at least one first bladder compartment connected to a seat cover and the second support zone including at least one second bladder compartment connected to the seat cover in spaced relation to the at least one first bladder compartment. A pump connected to the seat cover is actuated to provide pressurized fluid to a manifold. The manifold is controlled to selectively provide pressurized fluid to the at least one first bladder compartment and the at least one second bladder compartment in accordance with the desired first and second support levels, respectively.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a perspective view of a seat having the ergonomic seating system of the present disclosure attached thereto;

FIG. 2 is an enlarged cutaway perspective view of the lower portion of the ergonomic seating system of the present disclosure showing the controller, manifold and air bladder compartment incorporated therein;

FIG. 3 is an exploded perspective view of the controller and controller mounting system utilized to removably mount the controller to the seat cushion of the present disclosure;

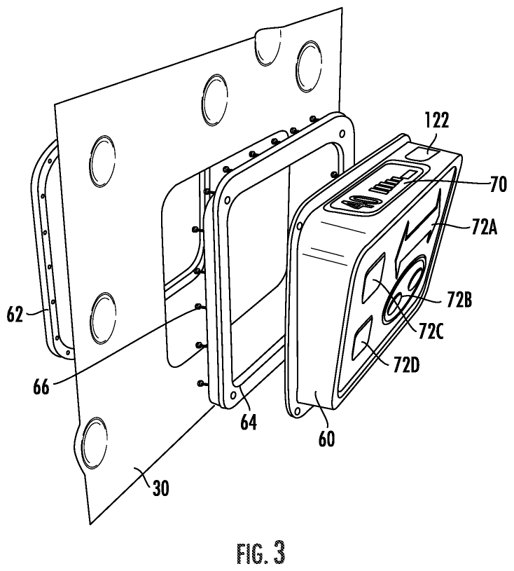

FIG. 4 is a partial perspective view of the controller mounted to the fabric/side wall of the ergonomic seating system of the present disclosure; and

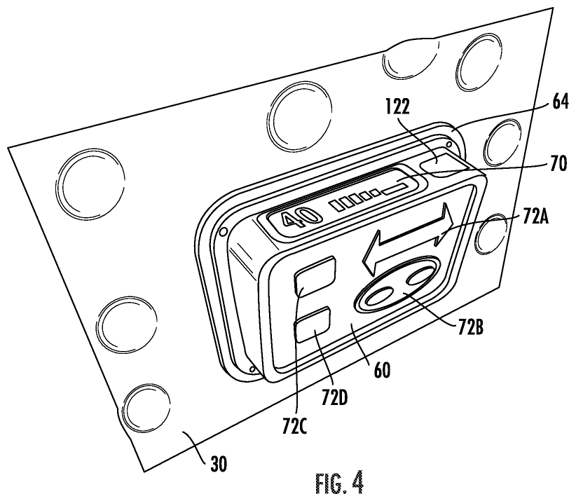

FIG. 5 is a schematic view of a bladder having several bladder zones, each being comprised of a plurality of fluidly interconnected bladder compartments.

Common reference numerals are used throughout the drawings and the detailed description to indicate the same elements.

### DETAILED DESCRIPTION

The detailed description set forth below in connection with the appended drawings is intended as a description of certain embodiments of a seat or seat cover with adjustable support capabilities and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Various aspects of the present disclosure relate to an ergonomic seating system which utilizes several discrete air bladder zones incorporated into a seat cover to allow for selective adjustment of the firmness or support within each discrete zone, as may be desired by a user. The seat cover may be formed as a separated element to be placed over an existing seat, or alternatively, may be incorporated directly into the seat as desired for all seating applications. A unique feature of the present disclosure is the use of a smart controller and a separate, internally mounted manifold which may selectively direct pressurized air to inflatable compartments integrated into the seat cover. The smart controller may be capable of facilitating a user selected firmness setting, e.g., between 1-50, similar to the Sleep Number® bed. Thus, the firmness or support throughout the seating system may be customized by the user to suit the user's unique body contours and comfort preferences.

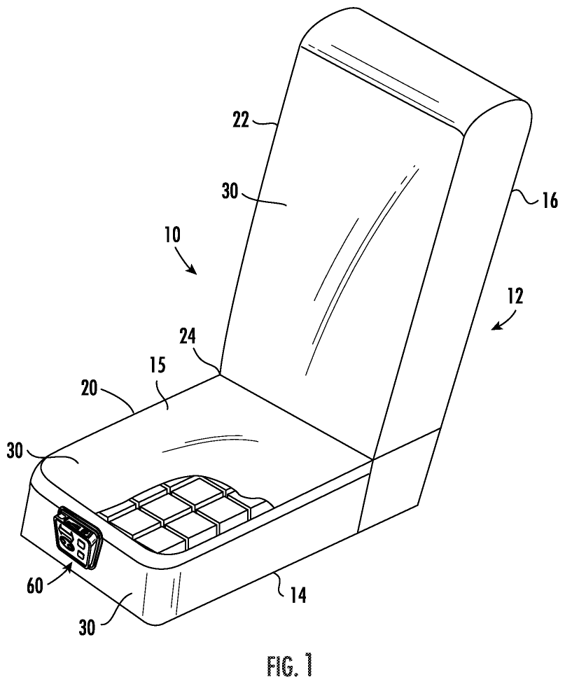

Referring now to FIG. 1, there is depicted an ergonomic seat system 10 of the present disclosure disposed on a seat 12. The exemplary seat 12 is a conventional automotive vehicle or truck seat 12 having a lower generally horizontal seat portion 14 and an upper generally vertical extending seat portion 16. Although depicted with a vehicular seat 12, the seating system 10 may be adapted for use in all seating applications including, but not limited to, office chairs, kitchen chairs, stadium seating, and all other commercial and residential seating surfaces.

According to one embodiment, the ergonomic seat system 10 may include a lower seat portion 20 and an upper seat portion 22, which may be interconnected along a fold line 24 or seam. The lower portion 20 and the upper portion 22 may be attached via conventional techniques to the lower seat portion 14 and upper seat portion 16 of the seat 12. Although shown as being attached to the seat 12, those skilled in the art will recognize that the seating system 10 may additionally be incorporated directly to the seat 12 at the time of manufacture of the seat 12.

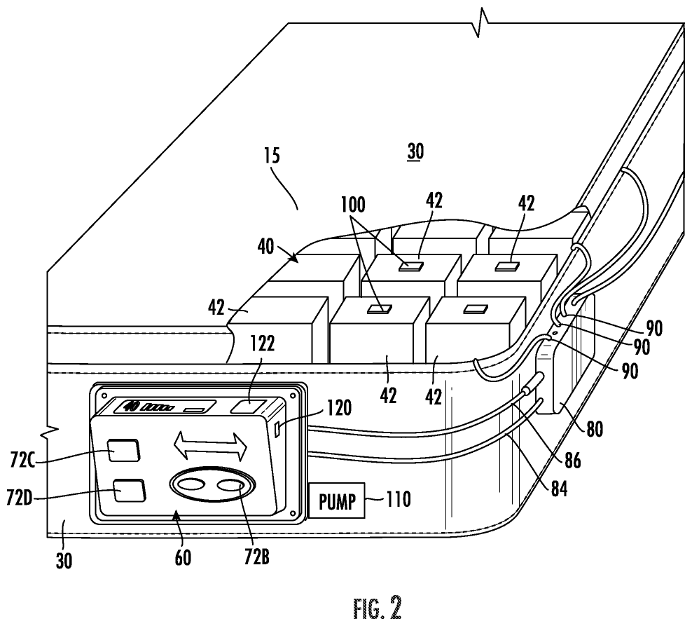

As shown in FIGS. 1 and 2, the seating system 10 may be formed to include a flexible, exterior cover layer 15 sized and configured to be extendable over at least a portion of the seat, and which is typically formed of an upholstered fabric, vinyl or leather material, which forms a comfortable seat cover 30. Disposed between upper and lower cover surfaces 30 of the seat system 10 is an air bladder 40, which is formed having a plurality of separate air bladder chambers or compartments 42. The air bladder compartments 42 can be fluidly interconnected to selective one or more adjacent air compartments 42 to define multiple air bladder zones to be disposed beneath particular anatomical regions of the user, both on the lower seating surface 20 and the upper seating surface 30 of the ergonomic seating system. For instance, a first zone may be located at the front of the lower seat portion 20, a second zone may be located at the rear of the lower seat portion 20, a third zone may be located at the lower end of the upper seat portion 22, a fourth zone may be located at the intermediate region of the upper seat portion 22, and a fifth zone may be located on the upper region of the upper seat portion 22. It is contemplated that left and right regions of the lower and upper seat portions 20, 22 may have respective bladder zones. In other embodiments, the bladder zones may be concentrically located, with an outer zone extending around an inner zone. In this regard, the shape, arrangement, and number of bladder zones may vary without departing from the spirit and scope of the present disclosure. Furthermore, although the air bladder 40 may be formed by various methods and in differing configurations, a preferred embodiment of the air bladder 40 is analogous to that developed and utilized by Roho, Inc., of Belleville, Ill.

Various embodiments of the seating system 10 includes an electronic controller/smart controller 60, which is preferably removably mounted to the seat cover and preferable disposed on the lower front portion of the seating system 10. However, the location and removability may be varied without departing from the spirit and scope of the present disclosure. To facilitate the removable mounting of the controller 60 to the cover 30, an inner mounting frame 62 and outer mounting frame 64 may be provided on opposite sides of the fabric cover 30. The outer frame 64 may include a plurality of pins 66, which are designed to extend through the fabric cover 30 and engage complementary shaped and positioned apertures formed in the inner frame member 62. With the pins 66 extending through the fabric cover 30 and inserted into the apertures of the inner base frame 62, the housing of the controller 60 can be removably mounted thereto. The housing may additionally include one or more mounting pins to enable the removable mounting of the controller 60 to the outer frame 64 via a similar pin aperture arrangement. Other suitable fastener, such as hook and loop fastener or snap fitting (not shown) are additionally contemplated.

The controller 60 may include a user interface, including a display 70 as well as multiple input buttons 72a, 72b, 72c, 72d, which facilitate automatic operation or user selected operation of selected pressurizing of the air bladder 40. For instance, the user may navigate through the user interface to select a specific zone, and either increase or decrease the pressure (and associated firmness) within the selected zone. Thus, the user interface may be configured to receive multiple user input commands, such as a first user input signal associated with a first prescribed pressure for a first support zone and a second user input signal associated with a second prescribed pressure for a second support zone, as will be described in more detail below.

The user interface may also allow a user to program and store a preferred comfort profile, with prescribed firmness settings in various regions of the seat. Thus, when the user is seated in the seat, the user may provide a command, via the user interface, to instruct the seat to conform to the previously programmed comfort profile. It is contemplated that multiple comfort profiles may be programmed to accommodate several users.

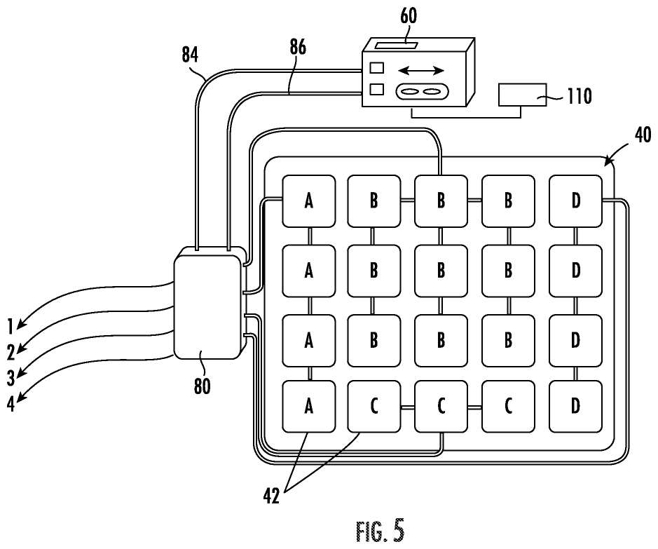

The controller 60 may communicate with a manifold 80, shown in FIGS. 2 and 5, via an air inlet line 84 and conventional electrical control lines(s) 86. The manifold 80 may include a plurality of output ports 90, each of which are in fluid communication with one or more air bladder compartments 42. An air pump 110, the operation of which may be controlled by the controller 60, may serve to provide increased air pressure through the manifold 80 and into one or more selected air compartments 42 so as to adjust the pressure in one or more air compartments 42. In this regard, the manifold 80 may be configured to selectively direct fluid from the pump 110 to the compartments 42 to achieve prescribed pressure(s) in the air compartments 42. When the air compartments 42 form multiple support regions or zones (e.g., a first set of compartments 42 defining a first zone and a second set of compartments 42 defining a second zone), the manifold 80 may be operable to direct fluid from the pump 110 into the bladder compartments 42 to achieve a respective pressure in the various compartments 42 (e.g., a first prescribed pressure in the first set of compartments 42 and a second prescribed pressure in the second set of compartments 42). The controller 60 may be configured to generate operational commands for both the pump 110 and the manifold 80 to achieve the prescribed pressures within each compartment 42 and/or zone.

An example of a bladder 40 having multiple zones, each being formed of one or more compartments 42, is depicted schematically in FIG. 5. Each zone is denoted by a different letter, such that the exemplary bladder 40 includes zones A, B, C, and D. The compartments 42 in zone A are interconnected to each other, and fluidly isolated from the compartments 42 in zones B, C, and D. Likewise, the compartments 42 in zone B are interconnected to each other, and fluidly isolated from the compartments 42 in zones A, C, and D. The compartments 42 in zone C are interconnected to each other, and fluidly isolated from the compartments 42 in zones A, B, and D, and finally, the compartments 42 in zone D are interconnected to each other, and fluidly isolated from the compartments 42 in zones A, B, and C. Each zone is supplied with air/fluid via its own, dedicated supply line, extending between the manifold 80 and the respective zone. In the schematic depicted in FIG. 5, the lines 1-4 extending from manifold 80 may supply fluid to an additional bladder 40 or zones. For instance, if zones A-D are located in a lower seat cushion, the lines 1-4 may supply fluid to a bladder located in a backrest seat cushion.

The air pump 110 may be connected to the cover layer 15 and may be selectively actuatable to supply fluid under pressure to air compartments 42, via the manifold 80. The pump 110 may be selectively actuatable to supply pressurized air or fluid on an as-needed basis. It is contemplated that the seat cover may include an inlet duct or other passageway extending through the cover layer 15 to provide an unobstructed inlet to the pump 110. In one embodiment, the pump 110 may be electric, while in other embodiments, the pump 110 may be manually operable. The pump 110 may be a standalone unit, or the pump 110 may be integrated into the controller 60, the manifold 80, or may be otherwise positioned, without departing from the spirit and scope of the present disclosure.

A pressurized fluid cartridge or tank may also be used, in combination with the manifold 80, to provide pressurized fluid to the air compartments 42. In this regard, the pressurized fluid cartridge or tank may be used in place of, or as a supplement, to the pump 110.

The manifold 80 may include a plurality of valves therein (not shown), which may selectively open and close selected outlet ports 90 of the manifold to allow the air pressure to be adjusted in one or more of the air compartments 42. In one embodiment, the manifold 80 is located at a remote location from the controller 60 for improved performance and manufacturing economies and to minimize the amount of pneumatic lines required for the seating system. In this regard, it is contemplated that pneumatic communication from the manifold 80 to the air compartments 42 may be facilitated either with internal or external pneumatic communication lines formed within or connected to the bladder 40, as desired.

Each outlet port 90 may be fluidly connected to a respective one of the first bladder compartment(s) 42 and the second bladder compartment(s) 42. At least one valve body may be in operative communication plurality of outlets. For instance, the valve body may be transitional between a first position and a second position to achieve desired filling of a prescribed bladder compartment 42. In the first position, each outlet fluidly connected to the first bladder compartment 42 may be open and each outlet fluidly connected to the second bladder compartment 42 may be closed, which results in a pressure increase in the first bladder compartment 42, while the pressure in the second bladder compartment 42 is unchanged. In the second position, each outlet fluidly connected to the second bladder compartment 42 may be open and each outlet fluidly connected to the first bladder compartment may be closed, which results in a pressure increase in the second bladder compartment 42, while the pressure in the first bladder compartment 42 is unchanged.

The manifold 80 may additionally include an exhaust outlet configured to facilitate exhausting of fluid from both the first bladder compartment 42 and the second bladder compartment 42. The exhaust outlet may be used when a reduction in pressure is desired by the user. The manifold 80 may be able to place the exhaust outlet in selective communication with one or more zones to allow for reduction of pressure from one zone with or without reducing pressure in another zone.

The controller 60, through conventional circuitry (e.g., processor(s)), software, and firmware serves to control the operation of the air pump 110, manifold 80, and air compartments 42 either automatically or through user selected operations.

A plurality of sensors, preferably pressure sensors 100, may be provided on or in one or more of the air compartments 42 to sense the pressure and weight distribution exerted upon a user when seated upon the ergonomic seating system 10 of the present disclosure. Each of the sensors 100 electrically communicates with the controller 60 to provide signals representing data indicative of a particular user sitting upon the ergonomic seat system 10 of the present disclosure over desired periods of time. The sensors 100 may be associated respective support zones on the seat cover. Thus, the sensors 100 may facilitate identification of the support level (e.g., pressure) within the various support zones on the seat cover. The readings from the sensors 100 may be used by the controller 60 to generate operational commands for the pump 110 and the manifold 80, based at least in part, on the readings of the sensors 100. For instance, if the seat cover includes a first support zone and a second support zone, and the user has selected a firmness level 10 for the first support zone and a firmness level 8 for the second support zone, the sensors 100 may provide the pressures within the first and second support zones. The controller 60 may compare the detected pressures with those associated with the selected firmness levels and add pressurized fluid to the support zones if the detected pressure is below the pressures associated with the desired firmness levels, or cause fluid to be vented from the support zones in the event the detected pressures are above those associated with the selected firmness levels.

In one embodiment, the sensors 100 may be used to identify a specific user sitting on the seat cover. For instance, each user may be associated with a given weight, and the sensors 100 may be able to detect the weight of the individual sitting on the seat cover based on a changed in pressure within the bladder compartments 42 when the user sits on the seat cover. The controller 60 may have preprogrammed comfort profiles for various user weights. Thus, when a user with a detected weight of 175 pounds sits on the seat cover, the controller 60 may operate the pump 110 and manifold 80 to achieve a first comfort profile, and when another user with a detected weight of 125 pounds sits on the seat cover, the controller 60 may operate the pump 110 and manifold 80 to achieve a second comfort profile.

As shown in FIG. 2, the controller 60 preferably includes a conventional USB port 120 as well as an auxiliary battery 122 to allow recharging of the controller 60 via differing conventional charging systems. The controller 60 may additionally include a memory circuit to allow for storing of data and instructions thereon to facilitate implementation of the functionalities described herein.

It is contemplated that the seat cover may additionally include a communications circuit, either integrated into the controller 60 or in operative communication with the controller 60 and configured to facilitate communications with an external device. For instance, it is contemplated that the communications circuit may allow for communication with a user's smartphone via Bluetooth® communication, or communications over WiFi or other wireless communication protocols. For instance, the user may be able to download an application (“app.”) that allows the user to enter desired pressures or support levels via the smartphone, which would then be communicated to the controller via the communications circuit. It is also contemplated that readings from the various sensors included in the seat cover may be communicated to the user's smartphone via the communication circuit and displayed on the smartphone for the user.

In operation, a user can choose to pair the controller 60 with an individual smartphone, tablet or the like if desired. The controller 60 controls and adjusts the air pressure within a given number of the air compartments 42 positioned throughout the lower 20 and upper 22 portions of the seating system 10 of the present disclosure. The controller 60 sends signals to the manifold 80 to either increase or decrease the air pressure within any given air compartment 42. Sensors 100 placed at multiple locations throughout the upper 22 and lower 20 seat portions of the seating system 10 of the present disclosure may constantly monitor the user's medically suggested weight distribution and sends electric signals to the controller 60 to adjust the appropriate amount of air provided or removed from the air compartments 42 through the manifold 80. In this regard, selected valves within the manifold 80 may be opened or closed via control signals from the controller 60 to increase and/or decrease air pressure within one or more of the air compartments 42. The user can also bypass the sensors 100 manually, if desired, by use of one or more input buttons 72a, 72b, 72c or 72d formed on the controller 60 to adjust the air pressure within any number or zones of individual air compartments 42. The controller 60 may be removed as desired from the seat cover 30 to provide software upgrades and serviceability to the controller 60. The controller 60 preferably is designed to provide a constant feedback to a monitoring company to provide a database to compile user pressure/comfort information to better understand the appropriate usage of the seating system 10 and provide information for further product improvement. It is additionally contemplated that software upgrades and the like can be facilitated utilizing Wi-Fi communications from a smartphone, tablet or computer.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A seat cover configured to be disposable on a seat to provide selectively adjustable support to a user seated on the seat, the seat cover comprising:
a cover layer configured to be extendable over at least a portion of the seat;
a pump connected to the cover layer and configured to supply fluid under pressure;
a first bladder compartment connected to the pump to receive fluid under pressure therefrom;
a second bladder compartment connected to the pump to receive fluid under pressure therefrom; and
a manifold fluidly connected to the pump, the first bladder compartment, and the second bladder compartment, the manifold being configured to selectively direct fluid from the pump to the first and second bladder compartments to achieve a first prescribed pressure in the first bladder compartment and a second prescribed pressure in the second bladder compartment.

2. The seat cover recited in claim 1, further comprising a controller in communication with the pump and the manifold, the controller being configured to generate operational commands for both the pump and the manifold to achieve the first prescribed pressure and the second prescribed pressure.

3. The seat cover recited in claim 2, further comprising:
a first pressure sensor in fluid communication with the first bladder compartment to sense pressure within the first bladder compartment; and
a second pressure sensor in fluid communication with the second pressure to sense pressure within the second bladder compartment.

4. The seat cover recited in claim 3, wherein the first and second pressure sensors are in operative communication with the controller, the controller being configured to generate the operational commands for both the pump and the manifold based, at least in part, on the sensed pressures from the first pressure sensor and the second pressure sensor.

5. The seat cover recited in claim 2, wherein the controller includes a user interface configured to receive a first user input signal associated with the first prescribed pressure and a second user input signal associated with the second prescribed pressure.

6. The seat cover recited in claim 2, further comprising a communications circuit in operative communication with the controller, the communications circuit being configured to facilitate communication with an external computer.

7. The seat cover recited in claim 1, further comprising:
a first set of bladder compartments, the first bladder compartment being one of the first set of bladder compartments; and
a second set of bladder compartments, the second bladder compartment being one of the second set of bladder compartments.

8. The seat cover recited in claim 1, wherein the manifold includes a plurality of outlets, each outlet being fluidly connected to a respective one of the first bladder compartment and the second bladder compartment.

9. The seat cover recited in claim 8, further comprising at least one valve body in operative communication plurality of outlets, the at least one valve body being transitional between a first position, wherein each outlet fluidly connected to the first bladder compartment is open and each outlet fluid connected to the second bladder compartment is closed, and a second position, wherein each outlet fluid connected to the second bladder compartment is open and each outlet fluidly connected to the first bladder compartment is closed.

10. The seat cover recited in claim 1, wherein the manifold includes an exhaust outlet configured to facilitate exhausting of fluid from both the first bladder compartment and the second bladder compartment.

11. A seat configured to provide selectively adjustable support to a user seated thereon, the seat comprising:
a seat body;
a pump connected to the seat body and configured to supply fluid under pressure;
a first bladder compartment connected to the pump to receive fluid under pressure therefrom;
a second bladder compartment connected to the pump to receive fluid under pressure therefrom; and
a manifold fluidly connected to the pump, the first bladder compartment, and the second bladder compartment, the manifold being configured to selectively direct fluid from the pump to the first and second bladder compartments to achieve a first prescribed pressure in the first bladder compartment and a second prescribed pressure in the second bladder compartment.

12. The seat recited in claim 11, further comprising a controller in communication with the pump and the manifold, the controller being configured to generate operational commands for both the pump and the manifold to achieve the first prescribed pressure and the second prescribed pressure.

13. The seat recited in claim 12, further comprising:
a first pressure sensor in fluid communication with the first bladder compartment to sense pressure within the first bladder compartment; and
a second pressure sensor in fluid communication with the second pressure to sense pressure within the second bladder compartment.

14. The seat recited in claim 13, wherein the first and second pressure sensors are in operative communication with the controller, the controller being configured to generate the operational commands for both the pump and the manifold based, at least in part, on the sensed pressures from the first pressure sensor and the second pressure sensor.

15. The seat recited in claim 12, wherein the controller includes a user interface configured to receive a first user input signal associated with the first prescribed pressure and a second user input signal associated with the second prescribed pressure.

16. The seat recited in claim 12, further comprising a communications circuit in operative communication with the controller, the communications circuit being configured to facilitate communication with an external computer.

17. The seat recited in claim 11, further comprising:
a first set of bladder compartments, the first bladder compartment being one of the first set of bladder compartments; and
a second set of bladder compartments, the second bladder compartment being one of the second set of bladder compartments.

18. The seat recited in claim 11, wherein the manifold includes a plurality of outlets, each outlet being fluidly connected to a respective one of the first bladder compartment and the second bladder compartment.

19. The seat recited in claim 18, further comprising at least one valve body in operative communication plurality of outlets, the at least one valve body being transitional between a first position, wherein each outlet fluidly connected to the first bladder compartment is open and each outlet fluid connected to the second bladder compartment is closed, and a second position, wherein each outlet fluid connected to the second bladder compartment is open and each outlet fluidly connected to the first bladder compartment is closed.

20. A method of adjusting support provided by a seat cover, the method comprising the steps of:
receiving a first input signal associated with a first support level in a first support zone, and a second input signal associated with a second support level in a second support zone, the first support zone including at least one first bladder compartment connected to a seat cover and the second support zone including at least one second bladder compartment connected to the seat cover in spaced relation to the at least one first bladder compartment;
actuating a pump connected to the seat cover to provide pressurized fluid to a manifold; and
controlling the manifold to selectively provide pressurized fluid to the at least one first bladder compartment and the at least one second bladder compartment in accordance with the desired first and second support levels, respectively.
